(19) United States
(12) Patent Application Publication
(10) Pub. No.: US 2006/0123115 A1
(43) Pub. Date: Jun. 8, 2006

(54) Information processing device control method

(76) Inventor: Shigeki Satomi, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/291,813

(22) Filed: Dec. 2, 2005

(30) Foreign Application Priority Data
Dec. 2, 2004 (JP) 2004-349695

(51) Int. Cl. G06F 15/173

(52) U.S. Cl. 709/226

(57) ABSTRACT

There is provided an information processing device control method for controlling an information processing device having a component management table for storing information indicating the components of the information processing system executing a plurality of application programs. The method includes a step for receiving an execution request of an application program is received; a step for selecting the components used when executing the application program requested to be executed by the information processing system, according to the information indicating the components stored in the component management table; and a step for transmitting a command for executing the application program requested to be executed by using the selected components.

### INCORPORATION BY REFERENCE

The present application claims priority from Japanese application JP 2004-349695 filed on Dec. 2, 2004, the content of which is hereby incorporated by reference into this application.

### BACKGROUND OF THE INVENTION

The present invention relates to an information processing device control method, an information processing device, and a computer-readable storage medium containing a program.

When a plurality of users share an information processing system, each user executes an application program by using resources such as a server and a storage device allocated to the user. In this case, a system administrator should perform various settings to allocate resources to each user. Moreover, each user prepares hardware, software, a network, and the like appropriate for the execution environment of each of the application programs to be executed and performs scheduling for executing the application programs.

Thus, when a plurality of application programs are executed in an information processing system, the resources of the information processing system are divided into a unit necessary for executing each application program before they are used. Moreover, various techniques for it are developed (for example, JP-A-2001-195268 and US 2002/0049719).

### SUMMARY OF THE INVENTION

When allocating resources of the information processing system to each application program in advance, the system administrator should select each resource, considering the execution format of the application program such as the execution format of the online real time processing, execution format of the delayed online processing, or execution format of the batch processing and divide the information processing system according to the execution format, thereby allocating it to each application program.

In this case, however, resources are allocated to each application program with an additional coverage so that no shortage of resources occurs during execution of the application program. This causes a resource division loss. Moreover, this causes lowering of the utilization rate of the resources. Furthermore, depending on the setting for allocating the resources, there may occur a resource conflict, i.e., a case when the same resource is required by a plurality of application programs being executed.

It is therefore an object of the present invention to provide an information processing device control method, an information processing device, and a program capable of improving the utilization rate of the resources.

In order to achieve the aforementioned object, the present invention provides an information processing device control method for controlling an information processing device having a component management table for storing information indicating each component of the information processing system executing a plurality of application programs. The method receives an application program execution request, selects the respective components used when executing the application program whose execution request has been received by the information processing system, and transmits a command causing to execute the application program whose execution request has been received, by using the components selected, to the information processing system.

Other objects and solutions disclosed by the present application will be made clear by the description of the invention and the drawings.

It is possible to provide an information processing device control method, an information processing device, and a program capable of improving the utilization ratio of the resources.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the entire configuration of a computer system according to an embodiment of the present invention.

FIG. 2 is a block diagram showing configuration of a center according to the present embodiment.

FIG. 3 is a block diagram showing configuration of an information processing system according to the present embodiment.

FIG. 4 is a flowchart showing a flow of processes according to the present embodiment.

FIG. 5 is a table showing an AP attribute database according to the present embodiment.

FIG. 6 is a table showing a resource database according to the present embodiment.

FIG. 7 is a table showing a calendar database according to the present embodiment.

FIG. 8 is a table showing an AP history database according to the present embodiment.

FIG. 9 is a table showing an end user database according to the present embodiment.

FIG. 10 shows a case when the application program according to the present embodiment consists of a plurality of programs.

FIG. 11 is a block diagram showing a case when the application program according to the present embodiment is executed in a plurality of information processing systems.

### DESCRIPTION OF THE INVENTION

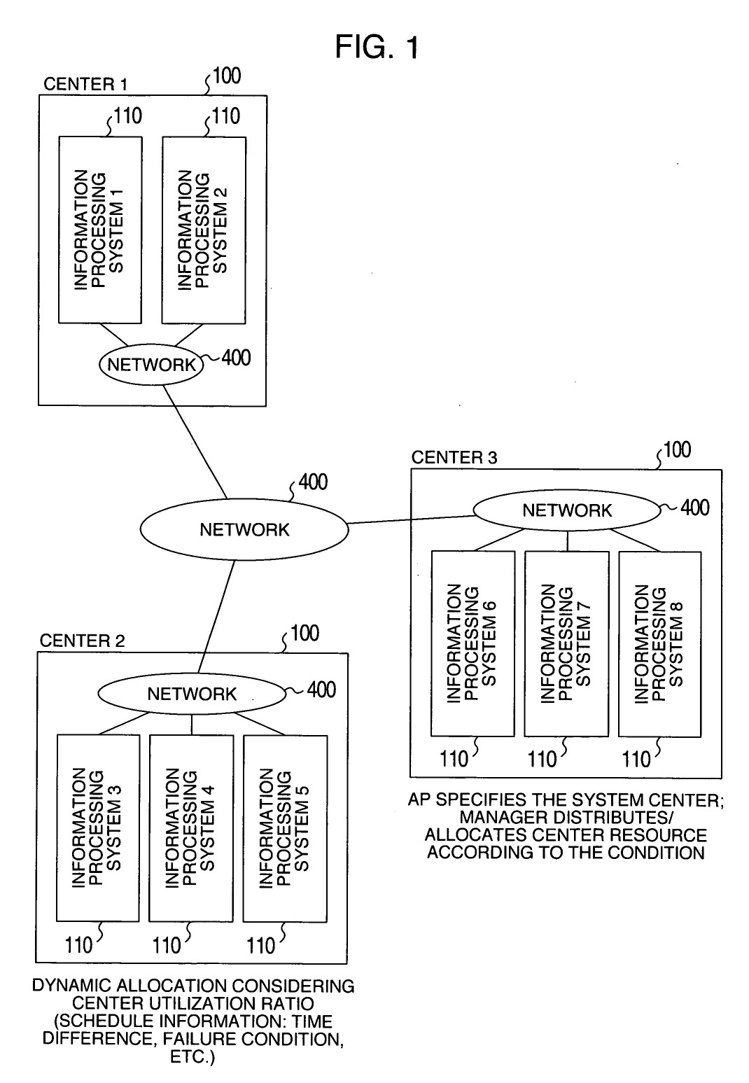

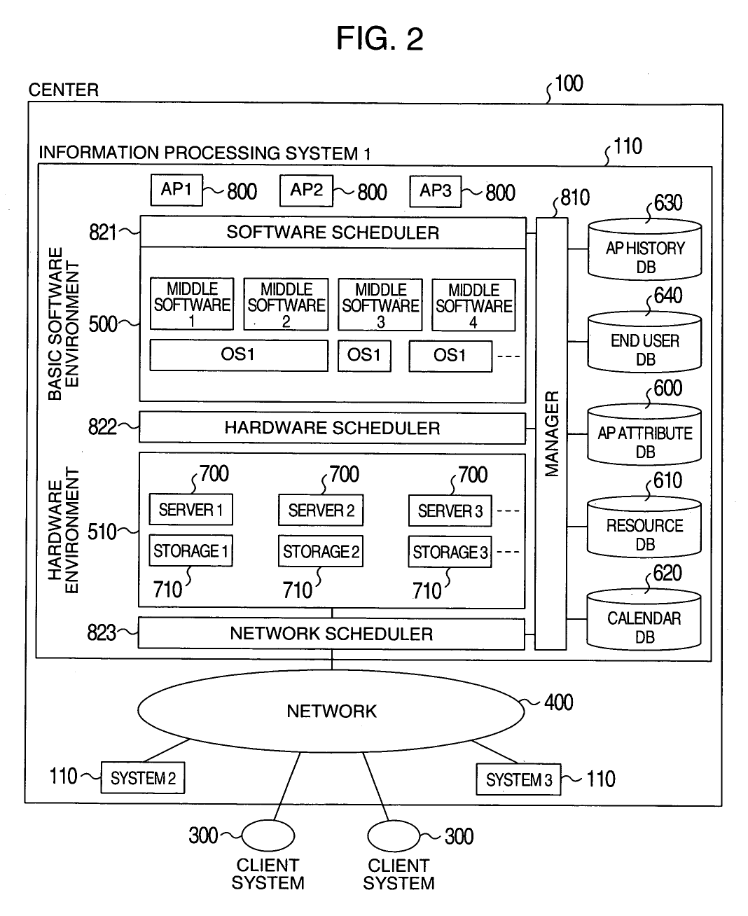

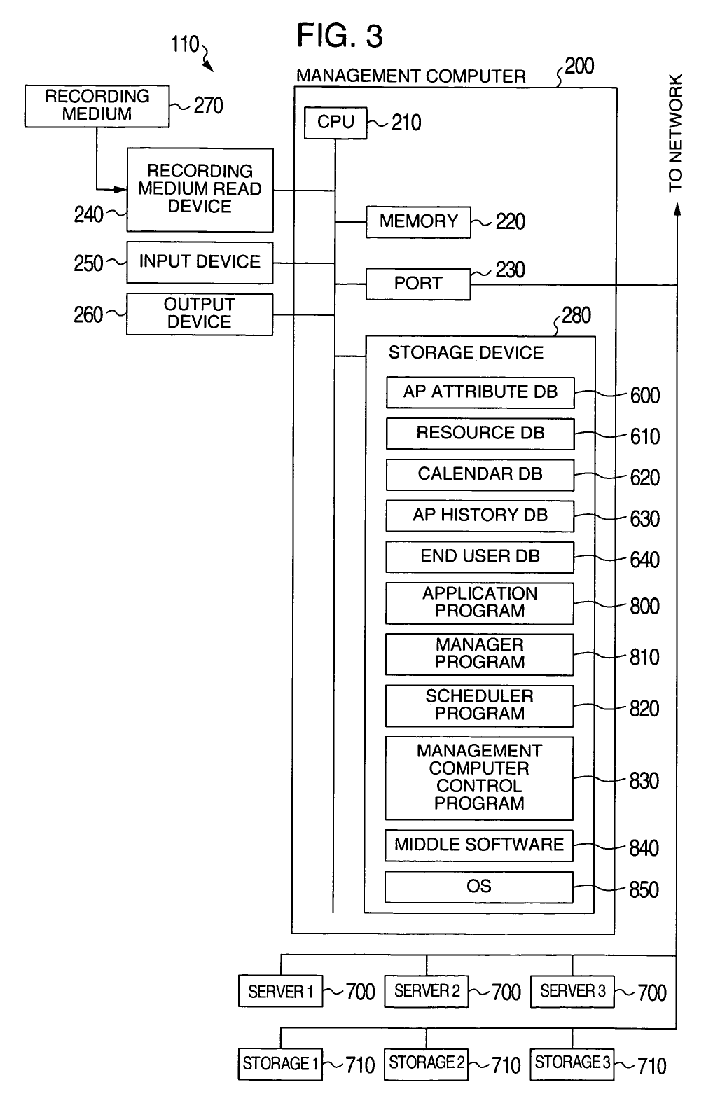

FIG. 1 shows configuration of a computer system according to a present embodiment. The computer system according to the present embodiment includes a center 1 (100), a center 2 (100), and center 3 (100) which are communicably connected via a network 400. Moreover, as shown in FIG. 2, each center 100 includes a plurality of information processing systems 110 which are communicably connected via the network 400. Furthermore, as shown in FIG. 3, each information processing system 110 is communicably connected to a management computer (corresponding to an information processing device described in claims) 200, a plurality of servers 700, and a plurality of storage devices 710.

As shown in FIG. 2, each of the information processing systems 110 is communicably connected to a client system 300 via the network 400. In each information processing system, when the management computer 200 receives an execution request of an application program 800 from the client system 300, the server 700 executes the application program 800. The execution result of the application program 800 is transmitted to the client system 300. Moreover, when the information processing system 110 receives an execution request of a plurality of application programs 800 from the client system 300, it executes a plurality of application programs 800 according to the request. The storage device 710 is a device for storing data used when the server 700 executes the application program 800.

As will be detailed later, in the information processing system 110 according to the present embodiment, when the management computer 200 receives an execution request of the application program 800 from the client system 300, it selects components (resources) of the information processing system 110 used when executing the application program 800. The components selected are, for example, the aforementioned server 700 and the storage device 810. Moreover, an operating system 850 for controlling the server 700 is also included here. Additionally, a middle software 840 executed in the server 700 may also be included here.

The management computer 200 controls the information processing system 110, i.e., the aforementioned respective components so that the application program 800 is executed by the selected components. That is, a command for executing the application program 800 by using the aforementioned components is transmitted to the aforementioned respective components of the information processing system 110.

===Configuration of Management Computer===

Next, explanation will be given on configuration of the management computer 200 with reference to FIG. 3.

The management computer 200 includes a CPU 210, a memory 220, a port 230, a recording medium read device 240, an input device 250, an output device 260, and a storage device 280.

The CPU 210 supervises the control of the entire management computer 200. The CPU 210 reads a management computer control program 830, a manager program 810, and a scheduler program 820 formed by codes for performing various operations according to the present embodiment and stored in the storage device 280 into the memory 220 and executes them, thereby realizing various functions as the management computer 200. For example, the management computer control program 830, the manager program 810, and the scheduler program 820 are executed by the CPU 210 and by cooperating with hardware devices such as the memory 220, the port 230, the input device 250, the output device 260, the storage device 280 and the like, an execution request reception unit, a component selection unit, and an execution request transmission unit are realized.

The management computer control program 830 receives an execution request of the application program 800 from the client system 300 and transmits the execution result of the application program 800 to the client system 300. Moreover, the management computer control program 830 selects a component of the information processing system 110 used for executing the application program 800. The component selection is performed by the management computer control program 830 which instructs the manager program 810 to perform selection.

According to the instruction from the management computer control program 830, the manager program 810 selects a component used for executing the application program 800. When the manager program 810 receives an instruction of a component selection from the management computer control program 830, it instructs the scheduler program 820 to select a component. As shown in FIG. 2, the scheduler program 820 according to the present embodiment is formed by a software scheduler 821, a hardware scheduler 822, and a network scheduler 823. The component selected by each of the schedulers is reported to the management computer control program 830 by the manager program 810.

The software scheduler 821 selects software required for executing the application program 800. As the software required for executing the application program 800, for example, there are an operating system 850 and middle software 840.

The middle software 840 is a program which is defined at a position between basic software such as the operating system 850 and application software such as the application program 800 and realizes basic functions and services common to various use fields. For example, the middle software 840 may be, for example, DBMS (DataBase Management System) software and communication management system software.

The hardware scheduler 822 selects hardware required for executing the application program 800. As the hardware required for executing the application program 800, for example, there are the server 700 and the storage device 710.

The network scheduler 823 selects a network device required for executing the application program 800. As the network device required for executing the application program 800, for example, there are a router, a hub, and a switch.

The recording medium read device 240 is a device for reading a program and data recorded on the recording medium 270. The program and data which have been read are stored in the memory 220 and the storage device 280. Accordingly, for example, the management computer control program 830, the manager program 810, and the scheduler program 820 recorded on the recording medium 270 can be read by using the recording medium read device 240 and stored in the memory 220 and the storage device 280.

As the recording medium 270, it is possible to use a flexible disc, a magnetic tape, a compact disc, or the like. The recording medium read device 240 may be built in the management computer 200 or attached to it from outside.

The storage device 280 may be, for example, a hard disc device and a semiconductor storage device. The storage device 280 stores the management computer control program 830, the manager program 810, the scheduler program 820, the application program 800, the middle software 840, the OS (Operating System) 850, the AP attribute database (also referred to as AP attribute DB) 600, the resource database (also referred to as resource DB) 610, the calendar database (also referred to as calendar DB) 620, the AP history database (also referred to as AP history DB) 630, and the end user database (also referred to as end user DB) 640. When the management computer 200 according to the present embodiment receives an execution request of the application program 800 from the client system 300, the management computer 200 selects a component of the information processing system 110 required for executing the application program 800, by referencing the AP attribute database 600, the resource database 610, and the calendar database 620. Details will be given later.

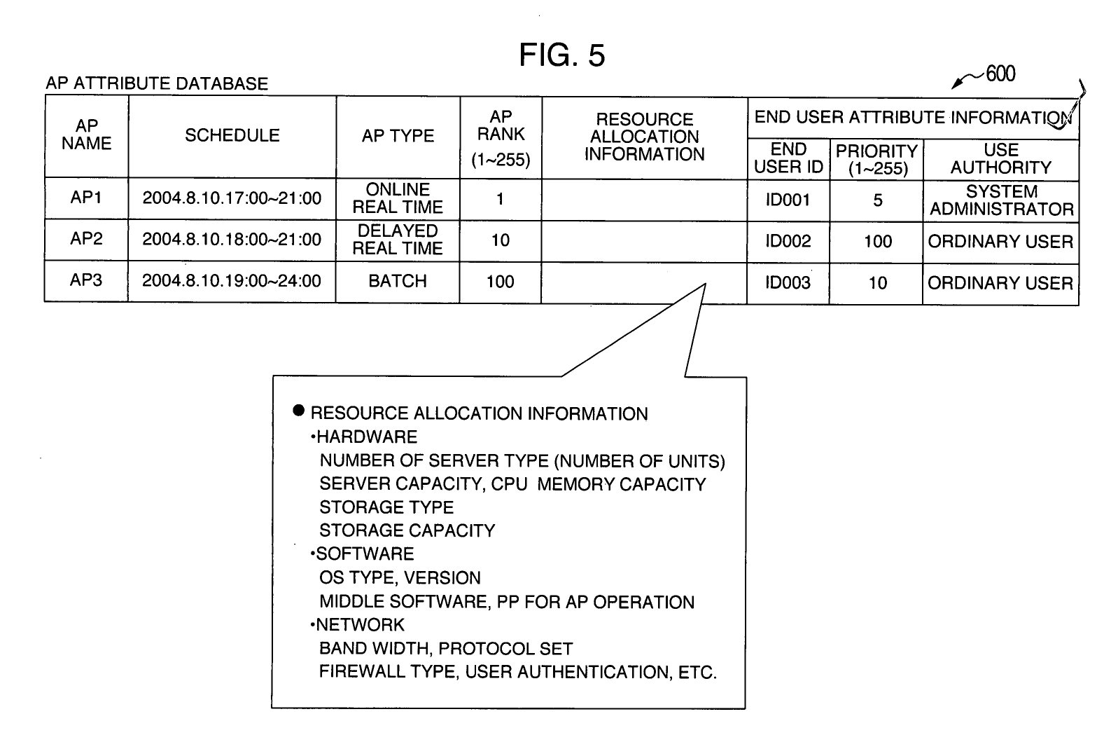

The AP attribute database 600 is a table for recording information on the execution request of the application program received by the management computer 200 from the client system 300. These information are transmitted from the client system 300 together with the execution request of the application program. FIG. 5 shows an example of the AP attribute database 600.

As shown in FIG. 5, the AP attribute database 600 includes a column of “the AP name”, a column of “the schedule”, a column of “the AP type”, a column of “the AP rank”, a column of “the resource allocation information”, and a column of “the end user attribute information”.

The column of “the AP name” describes an identifier of the application program 800 which has been requested to be executed from the client system.

The column of “the schedule” describes information on the schedule according which the application program 800 is executed in the information processing system 110. The information on the schedule includes, for example, the date when the application program 800 is executed, the execution start time, and the execution end time.

The column of “the AP type” describes the type of the application program 800 executed in the information processing system 110. The type of the application program 800 may be, for example, “online real time”, “delayed real time”, and “batch”. The “online real time” is a type of the application program 800 requiring a prompt process such as the online banking process and the aircraft seat reservation. The “delayed real time” is a type of the application program 800 not requiring the immediate process such as the online real time processing but requiring a rapid processing such as a delivery of commodities ordered. The “batch” is a type of the application program 800 which does not require a prompt processing and can be executed during night or on holidays when the information processing system load is small. For example, backup processing of a database is performed in the “batch”.

The column of “the AP rank” describes priority of the application program 800 which has been requested to be executed. That is, for example, when executing a plurality of application programs 800 at the same time and the same hardware should be used, the hardware is used for executing the application program 800 having a higher priority. In the present embodiment, the priority is represented by a numeric value from 1 to 255. As the numeric value becomes smaller, the priority becomes higher. It should be noted that the same time may include those shifted by a predetermined time.

The column of “the resource allocation information” describes the condition of the resource (component) allocated to the application program 800. For example, as the condition for hardware, it is possible to specify the type and quantity of the servers 700, the performance of the servers 700, the performance of the CPU, the memory capacity, the type and storage capacity of the storage device 710, and the like. As the condition for software, it is possible to specify the type and the version of the OS 850, and the program product group for executing the application program 800 such as the middle software 840 or the like. Moreover, as the condition for the network, it is possible to specify the band width, the protocol set, the type of the firewall, the user authentication, and the like.

The column of “the end user attribute information” describes information on the user who has made the execution request of the application program 800. In the example of FIG. 5, the column of “the end user attribute information” further has a column of “the end user ID”, a column of “the priority”, and a column of “the use authority”. The column of “the end user ID” describes, for example, a staff number if the user is a staff of a company. The column of “the priority” describes the priority when executing the application program 800 which is decided according to the end user. For example, when a resource conflict has occurred for the application program 800 requested to be executed from a plurality of end users, the application program 800 requested from the end user having the higher priority is executed with a higher priority. The column of “the use authority” describes the authority decided in accordance with the end user. For example, it is possible to limit usable resources in accordance with the use authority. For example, when executing an application program requested to be executed from a system administrator, all the storage devices 710 can be used and when executing an application program requested to be executed by an ordinary user, it is possible to prevent use of a particular storage device 710.

Thus, in the AP attribute database 600, it is possible to describe details of conditions for executing the application program 800. This enables accurate allocating of resources to each of the application program 800, so that each resource is used only when it is required. This improves the utilization ratio of each resource. It should be noted that the execution conditions of the application program 800 transmitted from the client system 300 may contain an unspecified condition. In this case, the management computer 200 can allocate resources to the application program 800 by allocating a resource defined by the default for the resource whose condition is not specified. Alternatively, it is possible to allocate an unused resource. Furthermore, it is also possible to specify all the conditions and transmit a message for again transmitting an execution request of the application program to the client computer 300.

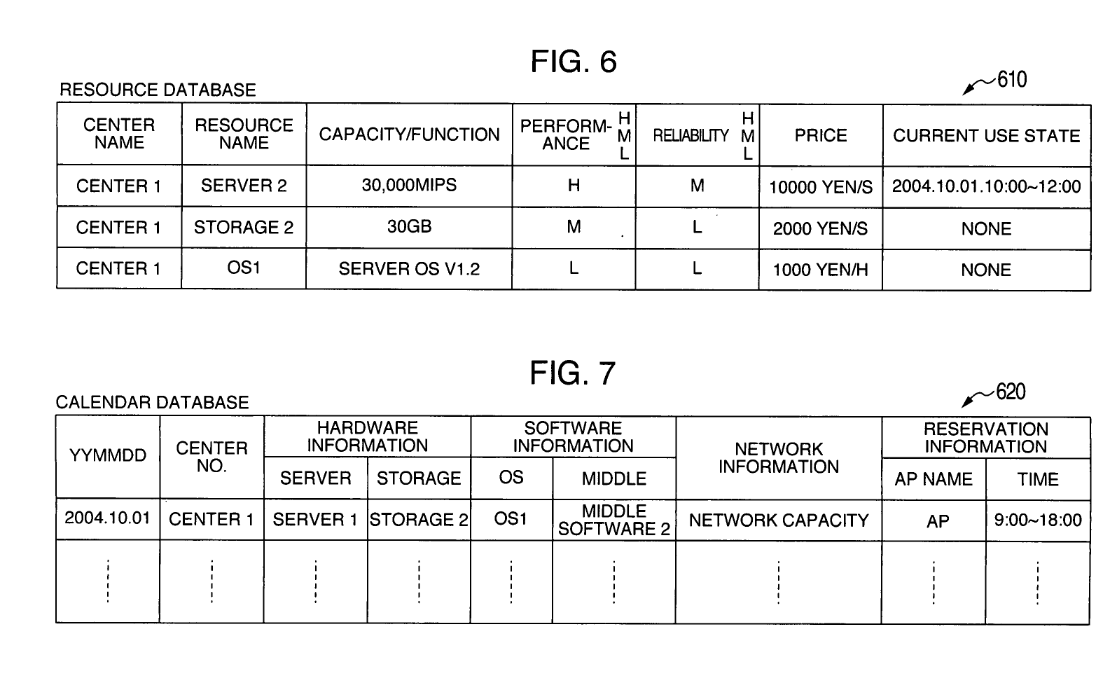

The resource data database 610 is a table storing information indicating each component of the information processing system 110. The resource database 610 is shown in FIG. 6. In the example of FIG. 6, for each of the “server 2”, “the storage 2”, and “OS 1” of the center 1 (100), “capacitance/function”, “performance”, “reliability”, “unit price”, and “current use condition” are described. When the management computer 200 receives an execution request of the application program 800 from the client system 300, it can know what kind of components are owned by the information processing system 110 by referencing the resource database 610. According to the information indicating each component described in the resource database 610, the management computer 200 selects the one satisfying the condition for executing the application program 800 as the components used when executing the application program 800 requested to be executed by the information processing system 110, from the components described in the resource database 610.

The calendar database 620 is a table for recording use reservation condition of the respective components of the information processing system 110. The calendar database 620 is shown in FIG. 7. When the management computer 200 receives a new execution request of the application program 800 from the client system 300, it can know the resource use plan by referencing the calendar database 620. The management computer 200 allocates a resource not planned to be used during executing of the application program 800 among the respective components of the information processing system 110, to the aforementioned application program 800. Moreover, when a resource is allocated to the application program 800, the management computer 200 records the resource allocation result in the calendar database 620. Moreover, according to the information described in the calendar database 620, the management computer 200 transmits a command for executing the application program 800 to the information processing system 110. That is, when the application program execution start time has come, the management computer 200 transmits an execution request command of the application program 800 to the information processing system 110.

Thus, by recording the use reservation state of each component of the information processing system 110 in the calendar database 620, the management computer 200 can transmit a command for executing the aforementioned application program 800 to the information processing system by using the resources allocated to the application program 800.

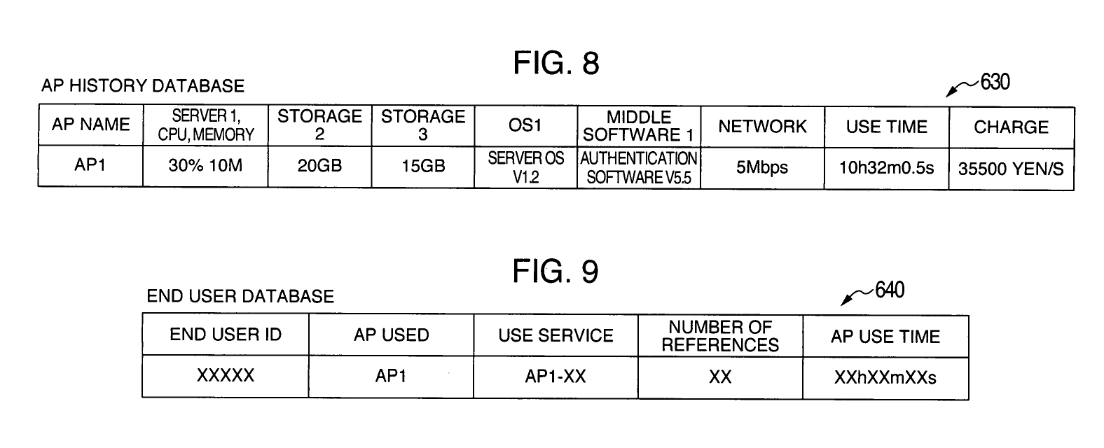

The AP history database 630 is a table for recording execution result information of the application program 800. The AP history database 630 is shown in FIG. 8. By using this, the management computer 200 can record which component of the information processing system has been used how much time for each of the application programs 800. Accordingly, it is possible to easily manage the charge of the information processing system 110 when the application program 800 is executed.

The end user database 640 is a table for recording the execution result information on the application program 800 for each of the end users (clients). The end user database 640 is shown in FIG. 9. By using this, the management computer 200 can record the execution time of the application program 800 of each end user. Accordingly, it is possible to easily manage the charge of the information processing system 110 when the application program 800 is executed.

Returning to FIG. 3, the input device 250 is a device used for data input to the management computer 200 and functions as a user interface. The input device 250 may be, for example, a keyboard and a mouse.

The output device 260 is a device for outputting information outside and functions as a user interface. The output device may be, for example, a display and a printer.

The port 230 is a device for performing communication. For example, communication with the client system 300, the server 700, the storage device 700, or an information processing device contained in the other information processing system 110 and other center 100 performed via the network 400 can be performed via the port 230. Moreover, for example, the management computer control program 830, the manager program 810, and the scheduler program 820 may be received from another information processing device via the network 400 and stored in the memory 220 and the storage device 280.

===Flow of Processes===

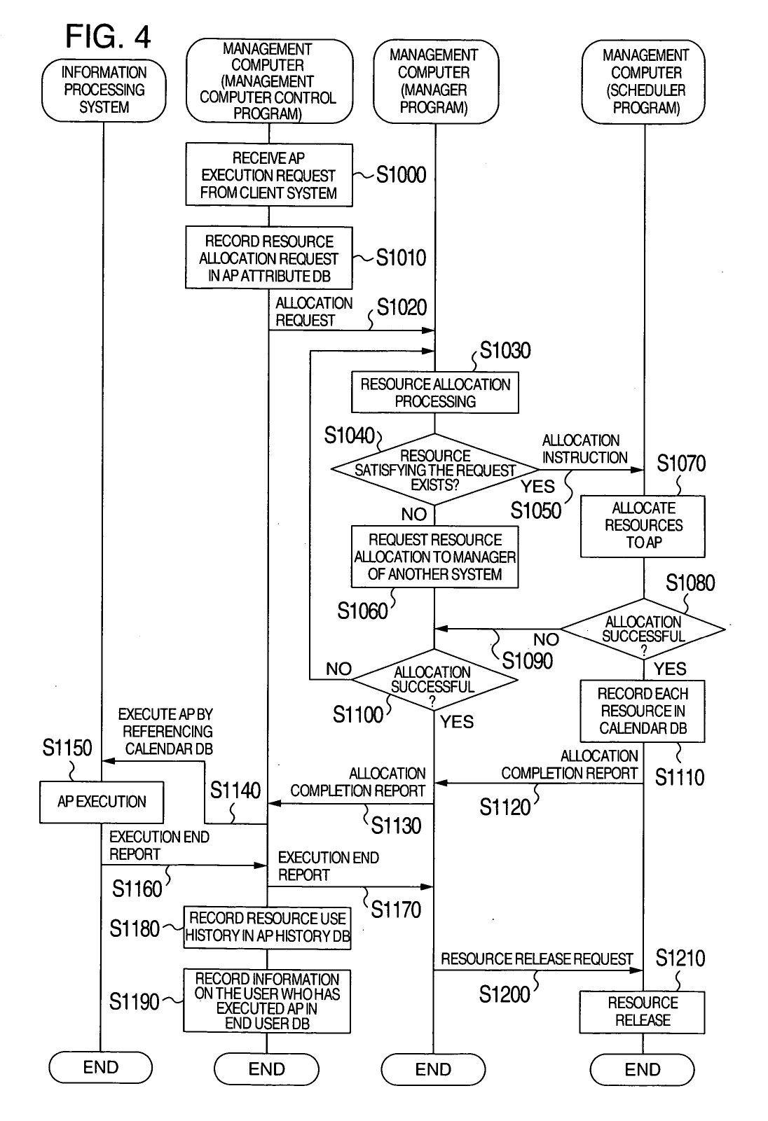

Next, referring to the flowchart of FIG. 4, explanation will be given on a case when the management computer 200 according to the present embodiment receives an execution request of the application program from the client system 300, i.e., a flow of the processes performed by the management computer 200: selection of components of the information processing system 110 for executing the application program 800 and execution of the application program 800 by using the selected components.

Firstly, when the management computer 200 receives an execution request of the application program 800 from the client system 300 (S1000), the management computer 200 records the resource allocation request in the AP attribute database 600 (S1010). Here, the resource allocation request is a condition for executing the application program 800 transmitted from the aforementioned client system 300. The resource allocation request is transmitted from the client system 300 together with the execution request of the application program 800. The management computer 200 executes the manager program 810 and performs a resource allocation request (S1020).

According to the information described in the AP attribute database 600 and the information described in the resource database 610, the manager program 810 performs resource allocation process (S1030). When a resource allocation satisfying the condition is performed, control is passed to “Yes” in S1040 and the manager program 810 instructs allocation of the respective resources to the respective scheduler program 820 (S1050).

According to the information described in the calendar database 620, the scheduler program 820 allocates the specified resource to the application program 800 (S1070). When the allocation is complete, control is passed to “Yes” in S1080 and the information on the allocated resources is recorded in the calendar database 620 (S1110). The scheduler program 820 transmits the information that the allocation of the resource specified by the manager program 810 is successful to the manager program 810 (S1120).

On the other hand, when allocation of the resources specified by the manager program 810 is not successful, the scheduler program 820 transmits that the allocation has failed to the manager program (S1090). In this case, the manager program 810 passes control to “No” in S1100 and repeats the process from S1030 and allocates other resources described in the resource database 610.

When the manager program 810 receives information that resource allocation is successful from the respective scheduler programs 820, it transmits information that resource allocation is successful to the management computer control program 830 (S1130).

The management computer control program 830 references the calendar database 620. When the execution start time of the application program 800 has come, the management computer control program 830 transmits an execution request command of the application program 800 to the respective resources of the information processing system 110 (S1140).

When the execution of the application program 800 is complete (S1150) and the execution completion report is transmitted from the server 700 (S1160), the management computer 200 transmits information that the execution of the application program 800 is complete to the manager program 810. The manager program 810 transmits a resource release request to the scheduler program (S1200) and the resources are released by the scheduler program 820 (S1210). It should be noted that the resource release means that the resource enter a state that it can be used by another application program 800.

On the other hand, the management computer control program 830 records the resource use history on the AP history database 630 (S1180). Furthermore, the management computer control program 830 records information on the end user who has executed the application program 800 on the end user database 640 (S1190) and transmits an execution result of the application program 800 to the client system 300, thereby terminating the process. It should be noted that the transmission of the execution result of the application program to the client system 300 can also be performed by the server 700 which has executed the application program 800.

When S1040 cannot allocate a resource satisfying the condition described in the AP attribute database 600, it means that the information processing system⁻¹¹⁰ does not have any resource which can be used when executing the application program 800. In this case, the manager program 810 passes control to “No” in S1040 and requests the management computer 200 of another information processing system 110 to allocate resources (S1060). That is, the manager program 810 transmits a command for causing the another information processing system 110 to execute the application program 800, to the management computer 200 of the another information processing system 110. When information that resources have been selected is received from the management computer 200 of the another information processing system 110, control is passed to “Yes” in S1100. The manager program 810 transmits information on that the resource has been allocated successfully to the management computer control program 830 (S1130). The management computer control program references the calendar database 620. When the execution start time of the application program 800 has come, the management computer control program 830 transmits an execution request command of the application program 800 to the respective resources of the another information processing system 110 (S1140).

Thus, in the information processing system 110 according to the present embodiment, if no resource is present to be allocated in the information processing system 110, it is possible to allocate a resource in another information processing system 110. This eliminates impossibility to execute the application program 800 because of the shortage of resources and increases the utilization ratio of the resources of the respective information processing systems 110.

Furthermore, when the application program 800 is formed by a plurality of programs, it is possible to use resources of different information processing systems 110 on each program unit so that the entire application program 800 is executed.

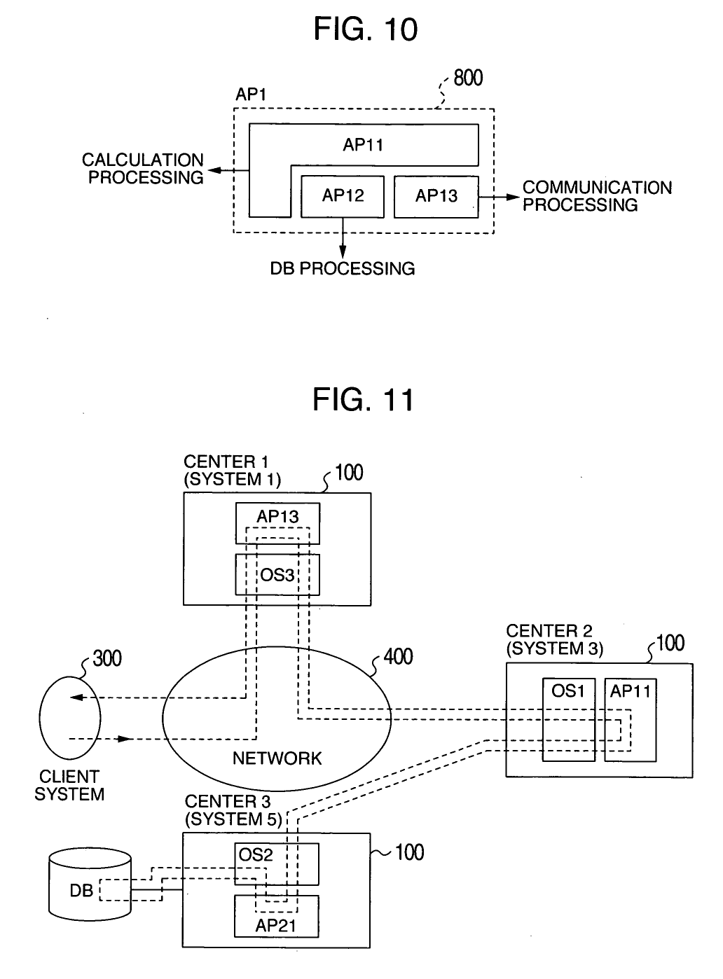

For example, when the application program AP1 (800) includes a program AP 11 for performing calculation, a program AP 12 for performing database processing, and a program AP 13 for performing communication processing as shown in FIG. 10, the following can be performed. That is, the AP 11 is executed under control of the OS 1 (850) in the information processing system 3 (110) of the center 2 (100), the AP 12 is executed under control of the OS 2 (850) in the information processing system 5 (110) of the center 3 (100), and the AP 13 is executed under control of the OS 3 (850) in the information processing system (110) of the center 1 (100) as shown in FIG. 11.

Thus, it is possible to flexibly allocate resources to the application program 800 and accurately control resource allocation. It is also possible to improve the utilization ratio of each resource.

Furthermore, when each scheduler program 820 allocates resources in S1070, by referencing the information described in the AP history database 630 and the information described in the end user database 640, it is also possible to allocate a resource different from the resource specified by the manager program 810. For example, when an execution request of the same application program 800 has been received from the same end user in the past and shortage of resources during execution of the application program occurs, it is possible to allocate a resource of a higher performance and larger capacity this time. Thus, the scheduler program 820 can correct the resources to be allocated to the application program 800, thereby enabling more appropriate resource allocation.

Explanation has been given on the present embodiment. According to the present embodiment, when an execution request of the application program 800 is received, it is possible to dynamically allocate resources used for executing the application program 800. Thus, each resource is used only when it is required. This improves the utilization ratio of each resource.

Moreover, when no resource is present in the information processing system 110, it is possible to allocate a resource to another information processing system. This eliminates impossibility of execution of the application program because of shortage of resources and increases the utilization ratio of each resource of the information processing systems 110.

Furthermore, by acquiring the use history from the allocation information on each resource allocated to the application program 800, it is possible to easily grasp the utilization state of each resource and easily realize charge on the end user.

Explanation has been given on the best mode for carrying out the present invention. The aforementioned embodiment has been given for facilitating the understanding of the present invention and does not limit the interpretation of the present invention. The present invention can be modified and improved without departing from the spirit of the invention and includes the equivalents.

It should be further understood by those skilled in the art that although the foregoing description has been made on embodiments of the invention, the invention is not limited thereto and various changes and modifications may be made without departing from the spirit of the invention and the scope of the appended claims.

1. An information processing device control method for controlling an information processing device having a component management table for storing information indicating components of the information processing system executing a plurality of application programs, the method comprising steps of:
receiving an execution request of an application program,
selecting components used when the information processing system executes the application program requested to be executed, according to the information indicating the components stored in the component management table, and
transmitting a command for executing the application program requested to be executed by using the selected components, to the information processing system.

2. The information processing device control method as claimed in claim 1, wherein
the information processing device is communicably connected to another information processing device controlling another information processing system executing a plurality of application programs,
when the information processing system cannot select components used for executing the application program requested to be executed according to the information indicating the components stored in the component management table, it transmits a command for causing the another information processing system to execute the application program requested to be executed, to the another information processing device, and
when the information processing system receives information that components used for executing the application program requested to be executed by the another information system have been selected, from the another information processing device, it transmits a command for executing the application program requested to be executed by using the selected components of the another information processing system.

3. The information processing device control method as claimed in claim 1, wherein the information processing system comprises as components:
a plurality of servers for executing the application program,
a plurality of storage devices for storing data, and
a plurality of operating systems for controlling the server.

4. An information processing device comprising:
a component management table for storing information indicating components of the information processing system executing a plurality of application programs,
an execution request reception unit for receiving an execution request of the application program,
a component selection unit for selecting components used when executing the application program requested to be executed by the information processing system according to the information indicating the components stored in the component management table, and
an execution request transmission unit for transmitting a command for executing the application program requested to be executed by using the selected components, to the information processing system.

5. The information processing device as claimed in claim 4, wherein
the information processing device is communicably connected to another information processing device controlling another information processing system executing a plurality of application programs,
when the information processing system cannot select components used for executing the application program requested to be executed according to the information indicating the components stored in the component management table, it transmits a command for causing the another information processing system to execute the application program requested to be executed, to the another information processing device, and
when the information processing system receives information that components used for executing the application program requested to be executed by the another information system have been selected, from the another information processing device, it transmits a command for executing the application program requested to be executed by using the selected components of the another information processing system.

6. The information processing device as claimed in claim 5, wherein the information processing system comprises as components:
a plurality of servers for executing the application program,
a plurality of storage devices for storing data, and
a plurality of operating systems for controlling the server.

7. A storage medium which can be read by the information processing device containing a program of the steps described in claim 1 and executed by the information processing device having the component management table storing the information indicating the components of the information processing system executing a plurality of application program.

8. The storage medium as claimed in claim 7, wherein
the information processing device is communicably connected to another information processing device controlling another information processing system executing a plurality of application programs,
when the information processing system cannot select components used for executing the application program requested to be executed according to the information indicating the components stored in the component management table, it transmits a command for causing the another information processing system to execute the application program requested to be executed, to the another information processing device, and
when the information processing system receives information that components used for executing the application program requested to be executed by the another information system have been selected, from the another information processing device, it transmits a command for executing the application program requested to be executed by using the selected components of the another information processing system.

9. The storage medium as claimed in claim 7, wherein the information processing system comprises as components:
a plurality of servers for executing the application program,
a plurality of storage devices for storing data, and
a plurality of operating systems for controlling the server.

10. An information processing device for executing a predetermined information processing according to a program comprising:
a storage device containing a component management table for storing information indicating the components of the information processing system executing a plurality of application programs and the programs;
a processing device connected to the storage device and performing the following processes:
receiving an execution request of the application program, selecting the components used when executing the application program requested to be executed by the information processing system, according to the information indicating the components stored in the component management table, and issuing a command for executing the application program requested to be executed by using the selected components; and
a transmission device connected to a network which is connected to the processing device and the information processing system and transmitting the command to the information processing system.

11. The information processing device as claimed in claim 10, wherein
the information processing device is communicably connected to another information processing device controlling another information processing system executing a plurality of application programs,
when the information processing system cannot select components used for executing the application program requested to be executed according to the information indicating the components stored in the component management table, it transmits a command for causing the another information processing system to execute the application program requested to be executed, to the another information processing device, and
when the information processing system receives information that components used for executing the application program requested to be executed by the another information system have been selected, from the another information processing device, it transmits a command for executing the application program requested to be executed by using the selected components of the another information processing system.

12. The information processing device as claimed in claim 10, wherein the information processing system comprises as components:
a plurality of servers for executing the application program,
a plurality of storage devices for storing data, and
a plurality of operating systems for controlling the server.
